(19) United States
(12) Patent Application Publication
(10) Pub. No.: US 2024/0362581 A1
(43) Pub. Date: Oct. 31, 2024

(54) DETERMINING LIMITS FOR ATTRIBUTES OF AN ORDER FOR FULFILLMENT BY A PICKER USING A MACHINE-LEARNING MODEL

(71) Applicant: Maplebear Inc. (dba Instacart), San Francisco, CA (US)

(72) Inventors: Vladimir Katz, San Francisco, CA (US); Ajay Pankaj Sampat, San Francisco, CA (US); Fangzhou Wang, Oakland, CA (US); Wenqi Ge, Bellevue, WA (US); Charles Durham, San Francisco, CA (US); Kevin Shepherd, Austin, TX (US)

(21) Appl. No.: 18/141,397

(22) Filed: Apr. 29, 2023

(51) Int. Cl. G06Q 10/087; G06N 7/01; G06N 20/00

(52) U.S. Cl. CPC G06Q 10/087; G06N 7/01; G06N 20/00

(57) ABSTRACT

An online concierge system allows users to place orders for fulfillment by pickers. Orders have various attributes (e.g., dimensions, weight, contents, etc.), and the pickers may have corresponding characteristics affecting capability of fulfilling orders. To optimize allocation of orders to pickers for fulfillment, the online concierge system trains an order validation model that predicts a probability of a picker encountering a problem fulfilling an order based on characteristics of the picker and attributes of the order. The order validation model is trained from training examples based on previous orders and labels indicating whether a picker encountered a problem with fulfilling the order. The order validation model can then be used to predict deliverability of future orders or to specify limits on one or more attributes of orders for fulfillment.

### BACKGROUND

Online concierge systems receive orders for items from customers and provide an order to a picker (or a shopper), who fulfills the order. To fulfill an order, the online concierge system allocates the order to the picker, who obtains items in an order from a retailer. The picker fulfills the order by delivering the obtained items to a customer.

Different items have different attributes and different pickers have different characteristics. Items with certain attributes are limited to being obtained by pickers with certain characteristics. For example, items identified as alcohol are limited to being obtained by pickers over 21 years old. Additionally, items have different dimensions, so different combinations of items in an order cause different orders to have different dimensions; as various pickers have vehicles with different storage dimensions, the aggregated dimensions of items in an order limits fulfillment of the order to pickers having vehicles with storage dimensions equaling or exceeding the aggregated dimensions of items in the order. Similarly, items have different weights, and different pickers have different capabilities of moving or carrying different weights, limiting fulfillment of an order to pickers having a capability of moving at least a weight equaling an aggregated weight of items in the order.

A combination of attributes of items included in an order provides attributes for the order. For example, a combination of weights of items in an order comprises a weight of the order. As another example, a combination of dimensions of items in an order comprises dimensions of the order. Conventional online concierge systems maintain a set of rules specifying limits on different attributes of an order for fulfilling orders. For example, an online concierge system maintains a rule specifying a maximum weight for an order, with the rule limiting fulfillment of the order to pickers having a capability to move or to carry at least the maximum weight. However, conventional online concierge systems maintain fixed rules for attributes of an order that fail to account for changes in characteristics of pickers affecting capability for order fulfillment, which inefficiently allocates orders to pickers and potentially reduces a number of orders fulfilled by the online concierge system.

### SUMMARY

In accordance with one or more aspects of the disclosure, an online concierge system determines a set of attributes for received orders. An attribute of an order is based on attributes of items included in the order. For example, an attribute of an order is a weight of the order determined from aggregating weights of items included in the order. As another example, an attribute of an order is a dimension of the order based on dimensions of items included in the order. An example of a dimension of an order is a volume occupied by the order. Other attributes or an order may alternatively or additionally be determined.

The online concierge system maintains a corresponding limit associated with each attribute of an order. A limit of an attribute of an order specifies a value for the attribute resulting in at least a threshold probability of a picker having a problem with fulfilling the order. Hence, the limit of an attribute specifies a maximum value of the attribute allowing a picker to fulfill the order with less than a threshold probability of encountering a problem with order fulfillment. In various embodiments, if an attribute of an order has a value exceeding a corresponding limit for the attribute, the online concierge system 140 does not identify the order to pickers for selection, preventing pickers from attempting to fulfill orders with which a picker is likely to encounter a problem with order fulfillment.

In various embodiments, the online concierge system maintains an initial limit for each attribute of an order. While conventional online concierge systems maintain the initial values for limits over time, maintaining a fixed value for a limit of an attribute may impair overall order fulfillment by the online concierge system. For example, if a fixed limit of an attribute is lower than what pickers are capable of fulfilling, the online concierge system prevents pickers from selecting orders capable of being fulfilled, reducing an overall number of orders fulfilled by the online concierge system. If a fixed value for an attribute is higher than what pickers are capable of fulfilling, the online concierge system provides orders to pickers for selection that the pickers are unable to fulfill without encountering one or more problems. Customers experiencing problems with order fulfillment decreases customer satisfaction with the online concierge system and reduces a number of subsequent orders received by the online concierge system.

To maintain limits for attributes of order that more accurately reflect capabilities of pickers for fulfilling orders, the online concierge system trains and stores an order validation model based on orders previously fulfilled by pickers. The order validation model receives attributes of an order as input and outputs a probability of a problem with fulfilling the order. In some embodiments, the order attribute fulfillment model receives attributes of an order and characteristics of a picker and outputs a probability of the picker having a problem fulfilling the order. In various embodiments, the order validation model is a machine learning model comprising a set of weights stored on a non-transitory computer readable storage medium. The weights are parameters used by the order validation model to transform input data (attributes of an order) received by the order validation model into output data (a probability of a picker encountering a problem with fulfilling the order). The weights may be generated through a training process, whereby the order validation model is trained based on a set of training examples determined from previously fulfilled orders and labels associated with the training examples. The training process may include: applying the order validation model to a training example, comparing an output of the order validation model to the label associated with the training example, and updating weights of the order validation model through a back-propagation process. The weights may be stored on one or more computer-readable media in response to the comparison of the output of the order validation model to the label associated with a training example satisfying one or more criteria.

After training the order validation model, the online concierge system selects an attribute of an order and uses the order attribute fulfillment model to determine a limit for a value of the selected attribute. For the selected attribute, the online concierge system obtains a set of values for the selected attribute. The set includes multiple different values for the selected attribute. In some embodiments, a range between a maximum value of the set and a minimum value of the set is based on the selected attribute in some embodiments, so which attribute was selected affects the range of values included in the set.

The online concierge system applies the order validation model to attributes of orders having different values of the set for the selected attribute. In various embodiments, the online concierge system fixes values of other attributes of the order and changes the value of the selected attribute to a different value of the set, with the order attribute fulfillment module variously applied to different combinations of the fixed values of other attributes and values from the set for the selected attribute. Applying the order validation model to different values of the set for the selected attribute allows evaluation of how different values for the selected attribute affects a probability of a picker encountering a problem with fulfilling the order. In embodiments where the order validation model also receives characteristics of a picker as input, values of the characteristics of the picker are fixed as different values of the set are used for the selected attribute. Further, the online concierge system may apply the order attribute fulfillment model to a specific value of a characteristic of a picker in combination with each value of the set for the selected attribute and apply the order validation model to an alternative value of the characteristic of the picker in combination with each value of the set for the selected attribute. In the preceding example, the online concierge system accounts for effects of different values for the characteristic of the picker along with different values of the selected attribute on the probability of a picker encountering a problem with order fulfillment.

Applying the order validation model to the different values of the set for the selected attribute generates a set of probabilities of a problem with fulfilling an order that each correspond to a value of the set for the selected attribute. As the order validation model is trained from previously fulfilled orders, the probabilities of encountering a problem fulfilling the order determined by the order validation model reflect characteristics and capabilities of pickers for fulfilling orders. Based on the probabilities determined for different values of the selected attribute, the online concierge system selects a value for the limit of the selected attribute. In various embodiments, the online concierge system selects a probability that is less than a threshold probability and nearest to the threshold probability and selects the value corresponding to the selected probability as the limit for the selected attribute. Using the selection criteria in the previous example uses the threshold probability as a maximum probability of a problem with fulfilling the order, while selecting a probability nearest to the threshold probability and less than the threshold probability maximizes a number of orders that the online concierge system provides to pickers for fulfillment constrained by the threshold probability of a problem with fulfilling the order.

The online concierge system stores the selected value based on the probabilities of a problem with order fulfillment as the limit for the selected attribute. In various embodiments, the online concierge system modifies a previously stored limit for the selected attribute (e.g., the initial limit) to the selected value. Values of the selected attribute for subsequently received orders are compared to the selected value to determine whether a subsequently received order is capable of being fulfilled. In various embodiments, the online concierge system 140 periodically selects an attribute of orders and determines a limit for a value of the selected attribute through application of the order validation model to different potential values for the selected attribute, as further described above. This allows the limit to be periodically updated based on fulfillment of orders by pickers to account for variations in capabilities of pickers to fulfill orders over time. Such updating of the limit for one or more attributes of an order increases a number of orders capable of being fulfilled while reducing a probability of pickers encountering problems with order fulfillment from attributes of orders.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a flowchart of a method for determining one or more limits on attributes of orders for order fulfillment, in accordance with one or more embodiments.

FIG. 4 illustrates a process flow diagram of a method for determining one or more limits on attributes of orders for order fulfillment, in accordance with one or more embodiments.

FIG. 5 illustrates a flowchart of a method for determining whether a picker is capable of fulfilling an order using an order validation model, in accordance with one or more embodiments.

### DETAILED DESCRIPTION

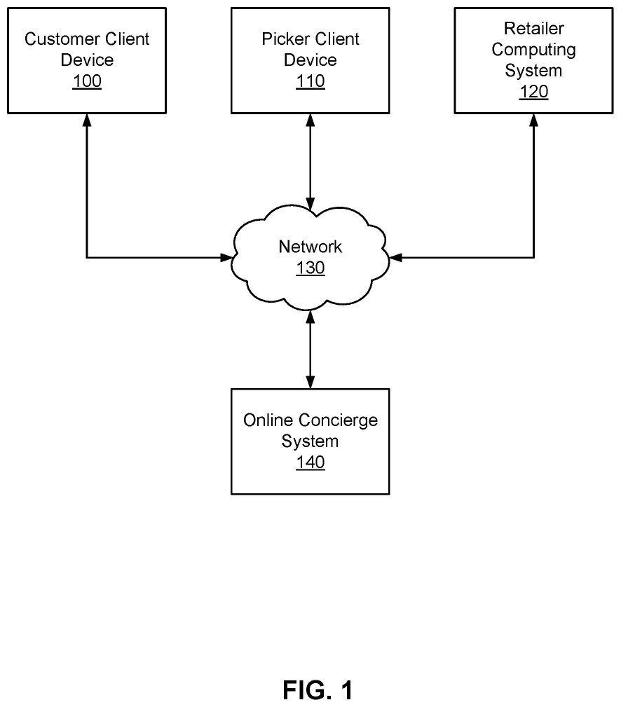

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

In various embodiments, the online concierge system 140 determines attributes of an order received from a customer based on items included in the order. Attributes of an order are determined based on attributes of items included in the order. One or more attributes of the order are determined by aggregating or otherwise combining attributes of items included in the order. For example, a weight of the order is determined by combining weights of items included in the order. As another example, one or more dimensions of the order are determined from dimensions of items included in the order; for example, a volume occupied by the order is determined from combining dimensions of items included in the order. Other example attributes of an order include whether an order includes an item limited to being obtained by a picker with at least a threshold age, an indication the order includes one or more items with greater than a threshold dimension in the order, and a total number of items in the order. However, different or additional attributes of an order may be determined in various embodiments.

To reduce a likelihood of a customer being dissatisfied with order fulfillment, the online concierge system 140 maintains limits for each of a set of attributes of an order. The online concierge system 140 compares attributes of a received order to a corresponding limit. In various embodiments, in response to an attribute of an order exceeding a corresponding limit, the online concierge system 140 does not allow a picker to fulfill the order. For example, the online concierge system 140 displays an interface to a customer from whom an order with an attribute exceeding a corresponding limit was received, with the interface including a message that the order is unable to be fulfilled. The interface may identify an attribute that exceeds a corresponding limit in some embodiments.

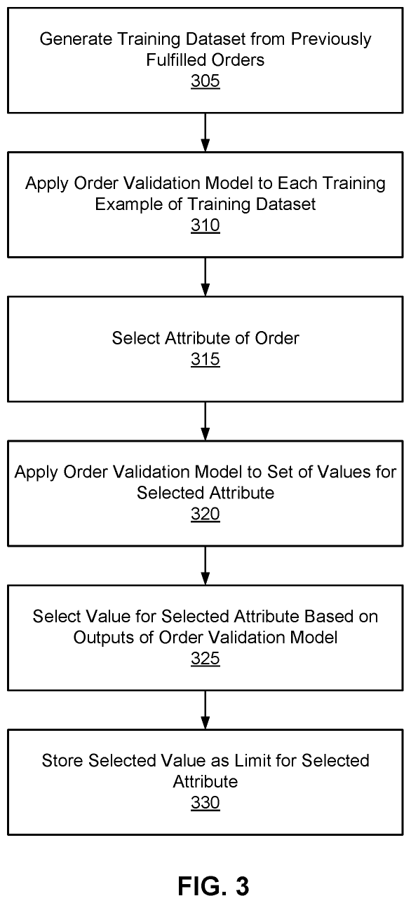

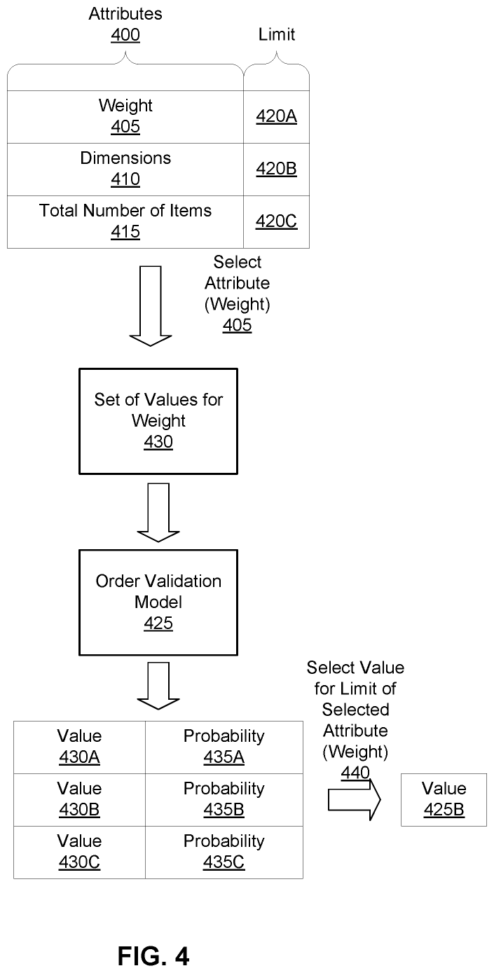

The online concierge system 140 trains and maintains an order validation model to determine limits for attributes of an order, as further described below in conjunction with FIGS. 3 and 4. The order validation model outputs a probability of a picker encountering a problem with fulfilling an order based on attributes of the order. For the limits of attributes to reflect capabilities of pickers, the online concierge system 140 trains the order validation model using attributes of previously fulfilled orders, as further described below in conjunction with FIGS. 3 and 4. Such training of the order validation model allows the limits to accurately reflect capabilities of pickers and allows the limits to be updated over time to reflect changes in capabilities of pickers.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In various embodiments, the picker client device 110 displays one or more order selection interfaces to a picker. An order selection interface may be displayed to a picker in response to the picker transmitting an indication to the online concierge system 140 that the picker is available to fulfill an order or in response to the picker requesting one or more orders for fulfillment. The selection interface displays information describing one or more orders available to be fulfilled to the picker, allowing the picker to select one or more orders for fulfillment based on the displayed information. Example information describing an order displayed by the order selection interface includes one or more attributes of the order (e.g., a number of items in the order, a weight of the order, one or more dimensions of the order), a location where the order is to be delivered, a retailer from which the order is to be fulfilled, or other information describing an order.

In various embodiments, the online concierge system 140 accounts for probabilities of a picker encountering a problem with fulfilling an order when generating the order selection interface. For example, the online concierge system 140 applies an order validation model to attributes of an order to determine a probability of a picker encountering a problem with order fulfillment, as further described below in conjunction with FIGS. 3-5. The online concierge system 140 visually differentiates orders for which a picker has at least a threshold probability of encountering a problem with order fulfillment from other orders for which the picker has less than the threshold probability of encountering a problem with fulfillment in an order selection interface in some embodiments. Alternatively, the online concierge system 140 withholds display of orders for which a picker has at least the threshold probability of having a problem with fulfillment from the order selection interface. The preceding embodiments allow the online concierge system 140 to reduce a likelihood of a picker selecting an order for fulfillment when there is at least a threshold probability of the picker having a problem with order fulfillment, increasing a likelihood of customer satisfaction with order fulfillment.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

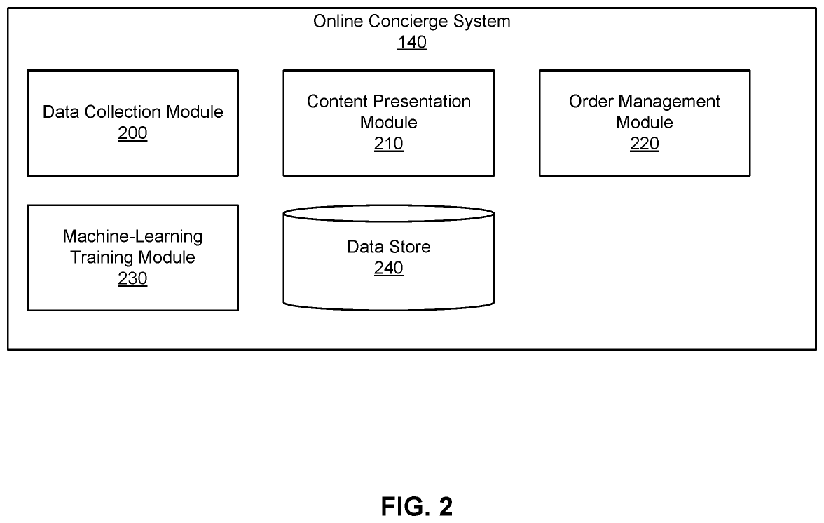

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

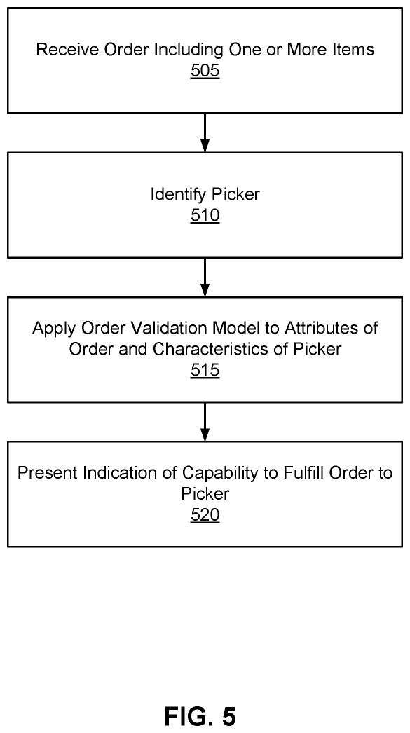

The order management module 220 may apply an order validation model to characteristics of a picker and to attributes of an order to determine whether to assign an order to a picker, as further described below in conjunction with FIG. 5. In various embodiments, the order validation model determines a probability of a picker having a problem with fulfilling an order based on characteristics of the picker and attributes of the order. The order management module 220 prevents assignment of an order to a picker in response to a probability of the picker having a problem fulfilling the order equaling or exceeding a threshold probability in various embodiments. Further, the order management module 220 may prevent display of an order to a picker for assignment or for selection in response to a probability of the picker having a problem fulfilling the order equaling or exceeding a threshold probability in various embodiments. The order validation model allows the order management module 220 to prevent assignment of an order to a picker with characteristics resulting in a threshold probability of the picker having a problem fulfilling the order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters. In various embodiments, the machine learning training module 230 trains an order validation model as further described below in conjunction with FIG. 3.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for determining one or more limits for attributes of orders for order fulfillment, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

As further described above in conjunction with FIG. 2, an online concierge system 140 maintains item data for items offered by one or more retailers, with item data for an item including attributes of the item. Example attributes of an item include dimensions of the item (e.g., height, width, depth), a weight of the item, a volume of the item, restrictions on characteristics of pickers capable of obtaining the item, as well as other descriptive information about the item. In various embodiments, the online concierge system 140 receives item data from a retailer, while in other embodiments, the online concierge system 140 receives item data from a manufacturer or from another entity associated with the item.

Additionally, the online concierge system 140 maintains picker data for each picker that identifies characteristics of the picker. Certain characteristics of the picker identify the capability of the picker for fulfilling one or more orders. For example, a characteristic of a picker indicates whether the picker is capable of purchasing age-restricted items (i.e., indicating the picker's age equals or exceeds a threshold age). As another example, a characteristic of a picker identifies a weight capable of being moved or carried by the picker, such as a maximum weight the picker is capable of moving or an indication whether the picker is capable of moving or of carrying at least a threshold amount of weight.

One or more characteristics of a picker also describe a capacity of a vehicle used by the picker. For example, a characteristic of the picker indicates dimensions available in the picker's vehicle for orders, such as a volume of the picker's vehicle capable of holding orders. In some embodiments, the characteristic of the picker identifies specific dimensions available in the picker's vehicle for orders. Alternatively, the characteristic of the picker identifies a type of the picker's vehicle, and the online concierge system 140 maintains associations between types of vehicles and ranges of dimensions available for orders. For example, a picker selects a type of vehicle from one or more interfaces displayed by the online concierge system 140. The online concierge system 140 stores the selected type of vehicle in association with an identifier of the picker.

When the online concierge system 140 receives an order from a customer, the online concierge system 140 accounts for attributes of the order when assigning or identifying orders to pickers. The online concierge system also accounts for characteristics of pickers when identifying or assigning orders to shoppers for fulfillment in some embodiments. At least some attributes of an order are determined by aggregating or otherwise combining attributes of items included in the order. For example, a weight of an order is determined as a sum of the weights of each item in the order. As another example, dimensions of the order are determined from combined dimensions of each item in the order, allowing a dimension of the order to provide an indication of one or more aggregated dimensions of the order. In some embodiments, the dimension of an order is an area or a volume of the order determined from dimensions of each item of the order. Alternatively, a dimension of an order is selected from a group of types, with each type corresponding to a range of areas or a range of volumes. For example, a dimension has a type selected from one of small, regular, bulky, or oversized, with each type having a corresponding range of areas or volumes for orders. In another example, an attribute of an order is an indication whether one or more items of the order are limited to being obtained by pickers having a specific characteristic (e.g., at least a threshold age).

To maximize orders available for assignment to pickers while reducing potential problems to a customer from fulfillment of orders, the online concierge system 140 accounts for attributes of an order when determining pickers to whom the order is presented for selection. In various embodiments, the online concierge system 140 also accounts for characteristics of a picker when determining whether an order is capable of being assigned to the picker. Additionally, the online concierge system 140 maintains limits on one or more attributes of an order, with a limit specifying a maximum value for the attribute of the order enabling fulfillment of the order by a picker. For example, a limit for a weight of an order identifies a maximum weight of a combination of items in the order capable of being moved or carried by a picker. In another example, a limit for dimensions of an order indicates a maximum for dimensions of an order (e.g., a maximum area, a maximum volume) capable of being included in a picker's vehicle. The online concierge system 140 may maintain different limits for different characteristics of a picker in some embodiments. For example, the online concierge system 140 maintains different limits for weights of an order for different types of vehicles, allowing the online concierge system 140 to account for variations in available space for items in different vehicles.

To optimize limits for one or more attributes of an order, the online concierge system 140 trains and maintains an order validation model. The order validation model receives attributes of an order and outputs a fulfillment score for the order. Rather than maintaining fixed limits for one or more attributes, which may decrease a number of orders the online concierge system fulfilled by reducing a number of orders assigned to pickers, the order validation model allows the online concierge system 140 to determine limits for one or more attributes of an order based on prior fulfillment of orders by pickers. This allows the limits for attributes of orders to more accurately reflect capabilities of pickers for handling attributes of orders and allows the online concierge system 140 to update limits for attributes of orders over time based on fulfillment of different orders by pickers.

To train the order validation model, the online concierge system 140 generates 305 a training dataset from previously fulfilled orders. The training dataset includes multiple training examples. Each training example includes attributes of an order with a label applied to the attributes of the order. The label includes a metric describing problems with fulfilling the order. In some embodiments, the training example also includes characteristics of a picker who fulfilled the order, so a training example includes attributes of an order, characteristics of the picker who fulfilled the order, and the label with the metric describing problems with fulfilling the order. Example attributes of an order included in a training example include dimensions of the order, dimensions of items included in the order, a number of items included in the order, a weight of the order, weights of items included in the order, categories of items included in the order, quantities of different items included in the order, and any combination thereof. In embodiments where the training example includes characteristics of a picker, example characteristics of a picker include dimensions available in the picker's vehicle for orders, a weight capable of being moved or carried by the picker, whether the picker has at least a threshold age, any combination thereof. Additional or alternative attributes of an order or characteristics of a picker may be included in training examples in various embodiments.

In various embodiments, the metric describing problems with fulfillment of an order is based on feedback received from a customer for whom the order was fulfilled. For example, the metric is an indication whether the customer reported an issue with the order to the online concierge system 140, such as an indication whether the customer contacted a customer care department or a customer service department of the online concierge system 140 about the order. In some embodiments, the metric is based on a severity of an issue reported by the customer about the order to the customer care department. In various embodiments, the metric is determined based on a combination of customer actions in response to receiving the order, such as a rating of the order received from the user, contact to a customer care department about the order, or other interactions with the online concierge system 140 based on fulfillment of the order included in the training example.

After generating 305 the training dataset, the online concierge system 140 applies 310 the order validation model to each training example of the training dataset to train the order validation model. The order validation model predicts a probability of a problem with order fulfillment based on the attributes of an order. Problems with order fulfillment include an inability of the picker to obtain one or more items of the order with age restrictions, difficulty by the picker of moving or carrying the combination of items included in the order, difficulty by the picker in fitting the order into a picker's vehicle, or other reasons one or more items in the order may be damaged or not included in the order by the picker. In some embodiments, the probability of the problem with order fulfillment also accounts for characteristics of a picker fulfilling the order, so the order validation model receives attributes of an order and characteristics of a picker as input. In some embodiments, the order validation model receives attributes of an order and outputs the probability of a problem with order fulfillment by a picker. In other embodiments, the order validation model receives attributes of an order and characteristics of a picker fulfilling the order and outputs the probability of the problem with order fulfillment. The order validation model comprises a set of weights stored on a non-transitory computer readable storage medium in various embodiments.

For training, the online concierge system 140 initializes a network of a plurality of layers comprising the order validation model, with each layer including one or more weights. As described above, the order validation model receives attributes of an order and generates a probability of a problem with order fulfillment in some embodiments. In various embodiments, the order validation model receives attributes of an order and characteristics of a picker fulfilling the order and generates a probability of the picker having a problem with order fulfillment. The weights comprise a set of parameters used by the order validation model to transform the input data—the attributes of an order (or the attributes of the order in combination with characteristics of a picker)—received by the attribute selection model into output data—the probability of a problem with fulfilling the order.

The online concierge system 140 generates the parameters (e.g., the weights) for the order validation model through training by applying 310 the order validation model to multiple training examples of the training dataset that were generated from prior fulfillment of orders including various items by pickers. After initializing the set of weights comprising the order validation model, the online concierge system 140 applies 310 the order validation model to multiple training examples of the training dataset. In some embodiments, a training example includes attributes of an order, with a label applied to the training example comprising a metric indicating whether a customer reported a problem with fulfillment of the order to the online concierge system 140. In other embodiments, a training example includes attributes of an order and characteristics of a picker, with a label applied to the training example indicating whether a customer reported one or more problems with the order fulfillment to the online concierge system 140. Applying 310 the order validation model to a training example generates a probability of a problem with order fulfillment of the order included in the training example.

For each training example of the training dataset to which the order validation model is applied 310, the online concierge system 140 generates an error term based on a predicted probability of a problem with fulfilling the order for the training example output by the order validation model and the label applied to the training example. The error term is larger when a difference between the predicted probability of the problem with fulfilling the order and the label applied to the training example is larger and is smaller when the difference between the predicted probability of the problem with fulfilling the order and the label applied to the training example is smaller. In various embodiments, the online concierge system 140 generates the error term between the predicted probability of the problem with fulfilling the order output by the attribute selection model and the label applied to the training example using a loss function. Example loss functions include a mean square error function, a mean absolute error, a hinge loss function, and a cross-entropy loss function.

The online concierge system 140 backpropagates the error term to update the set of parameters comprising the order validation model and stops backpropagation in response to the error term, or to the loss function, satisfying one or more criteria. For example, the online concierge system 140 backpropagates the error term through the order validation model to update parameters of the attribute selection model until the error term has less than a threshold value. For example, the online system 140 may apply gradient descent to update the set of parameters. The online concierge system 140 stores the set of parameters comprising the order validation model on a non-transitory computer readable storage medium after stopping the backpropagation.

In various embodiments, the online concierge system 140 trains and stores an order attribute fulfillment model for each of a plurality of attributes of an order. This allows the online concierge system 140 to maintain order validation models specific to different attributes of an order. For example, an order fulfillment model is associated with a weight of the order, while a different order fulfillment model is associated with dimensions of the order. Training of each order validation model is performed as further described above.

The online concierge system 140 periodically retrains the order validation model in various embodiments. To retrain the order validation model, the online concierge system 140 generates additional training examples based on orders fulfilled between a time when the online concierge system 140 most recently trained the order validation model and a time when the online concierge system 140 retrains the model. The online concierge system 140 applies the order validation model to each of at least a set of the additional training examples and updates parameters of the order validation model based on predicted probabilities of a picker encountering a problem with order fulfillment output by the order validation model, as further described above. Periodically retraining the order validation model allows the online concierge system 140 to update the order validation model to account for changes in capabilities of pickers for fulfilling orders over time.

After training, the online concierge system 140 predicts or estimates a probability of a problem with fulfillment of an order based on attributes of items of the order using the order validation model. As the order validation model was trained based on prior fulfillment of orders, leveraging the order validation model allows the limits for attributes of the order to more accurately reflect picker capabilities for order fulfillment. The online concierge system 140 does not assign orders having a value for the attribute exceeding a corresponding limit to a picker for fulfillment. For example, the online concierge system 140 determines a maximum weight for an order and does not assign an order having a weight greater than the maximum weight to a picker for fulfillment. In various embodiments, the online concierge system 140 displays an interface or a prompt to a customer creating an order that the order cannot be fulfilled in response to a value of an attribute of the order equaling or exceeding a corresponding limit. The interface or prompt may identify an attribute of the order exceeding the corresponding limit, allowing the customer to modify the order more easily so it is capable of being fulfilled. Preventing assignment of an order with a threshold probability of having a problem with fulfillment to a picker decreases a likelihood of the customer being unsatisfied with fulfillment of the order. Reducing a likelihood of a customer being unsatisfied with fulfillment of an order increases subsequent interaction with the online concierge system 140 by the customer by increasing a number of subsequent orders the online concierge system 140 receives from the customer.

To minimize a probability of customers encountering problems with order fulfillment without excessively limiting a number of orders fulfilled by the online concierge system 140, the online concierge system 140 selects 315 an attribute of orders and applies 320 the order validation model to a set of values for the selected attribute. Application of the order validation model to different values of the set for the selected attribute generates a set of probabilities of encountering problems with fulfilling the order. As each probability of the problem with fulfilling the order corresponds to a different value of the selected attribute, the set of probabilities of the problem with fulfilling the order depicts how different values for the selected attribute change a resulting probability of the problem with fulfilling the order. In various embodiments, the online concierge system 140 fixes values for attributes of an order other than the selected attribute when applying 320 the order validation model to different values of the set.

Based on the set of probabilities of encountering the problem with fulfilling the order, the online concierge system 140 selects 325 a value for the selected attribute of orders. For example, the online concierge system 140 identifies a probability of having the problem with fulfilling the order that does not exceed a threshold probability and selects 325 a value for the selected attribute corresponding to the identified probability. As an example, the online concierge system 140 identifies a probability of having the problem with fulfilling the order that is nearest to the threshold probability and does not exceed the threshold probability. The online concierge system 140 stores 330 the selected value for the selected attribute as a limit for the selected attribute for subsequent comparison to values of the selected attribute. The online concierge system 140 modifies a stored value for the limit for the selected attribute to the selected value when storing 330 the selected value for the selected attribute.

In some embodiments, the online concierge system 140 periodically applies 320 the order validation model to the set of values for the selected attribute and selects 325 the value for the selected attribute of orders from the resulting probabilities of the problem with fulfilling the order. As the order attribute item fulfillment model is trained from fulfillment of orders by pickers, selecting 325 the value for the selected attribute of orders based on the order validation model allows the online concierge system 140 to determine a limit for the selected attribute that accounts for capabilities of pickers for order fulfillment identified from prior fulfillment of orders. The order validation model allows the online concierge system 140 to automatically update the limit for the selected attribute over time as pickers fulfill various orders, enabling modification of the limit for the selected attribute based on variations in how pickers fulfill orders.

In embodiments where the order validation model receives attributes of an order and characteristics of a picker fulfilling the order, the online concierge system 140 selects 315 the attribute of the order and selects a characteristic of pickers fulfilling the order. The online concierge system 140 applies 320 the order validation model to a set of values for the selected attribute and to one or more specific values for the selected characteristic. Based on the set probabilities of having the problem with fulfilling the order, the online concierge system 140 selects 325 a value for the combination of the selected attribute of orders and the selected characteristic of pickers, as further described above. Selecting both an attribute of an order and a characteristic of a picker allows the online concierge system 140 to select 325 different values for the selected attribute for different values of the selected characteristics of a picker. This allows the online concierge system 140 to specify different limits on the selected attribute that correspond to different values for the selected characteristic of a picker. For example, the online concierge system 140 selects 315 dimensions as the attribute of orders and selects a specific type of vehicle for a picker. The online concierge system 140 applies 320 the order validation model to different values for the dimensions of the order without changing values of other attributes of the order and to characteristics of pickers having the specific type of vehicle. Based on the outputs of the order validation model for different values of dimensions for the order, the online concierge system 140 selects 325 a value for the dimensions of an order that corresponds to pickers with a characteristic of the specific type of vehicle. The online concierge system 140 stores 330 the selected value as a limit on dimensions of the order for pickers having the specific type of vehicle. The online concierge system 140 may apply 320 the order validation model to an alternative value for the selected characteristic of a picker and to various values of the selected attribute of the order to select 325 a value for the selected attribute corresponding to the alternative value for the selected characteristic of a picker, allowing determination of different limits for the selected attribute that each correspond to different values of the selected characteristic of the shopper.

Determining limits for attributes of orders based on the order validation model, allows the limits for attributes of orders to reflect order fulfillment capabilities of pickers more accurately. This allows the online concierge system 140 to maximize a number of orders from customers assigned to pickers for fulfillment, while preventing customers from creating orders that pickers are unable to fulfill, increasing customer satisfaction with order fulfillment by the online concierge system 140. As the order validation model may be updated as orders are fulfilled by pickers, use of the order validation model also allows the limits for one or more attributes of orders to be updated over time to reflect changes in capabilities for order fulfillment of pickers.

FIG. 4 is a process flow diagram of a method for determining one or more limits on attributes of orders for order fulfillment. As shown in FIG. 4, the online concierge system 140 maintains a set of attributes 400 for orders, with each attribute associated with a corresponding limit 420A-C (also referred to individually and collectively using reference number 420). In the example of FIG. 4, the set of attributes 400 includes a weight 405 of an order, dimensions 410 of an order, and a total number 415 of items in an order. However, additional or alternative attributes 400 for an order are maintained by the online concierge system 140 in various embodiments. Each attribute 400 has a corresponding limit specifying a value for the attribute resulting in at least a threshold probability of a picker having a problem with fulfilling the order. In the example of FIG. 4, limit 420A specifies a maximum value for the weight 405 of an order, limit 420B specifies a maximum value for dimensions 410 of an order, and limit 420C specifies a maximum value for a total number 415 of items in an order. If an attribute of an order has a value exceeding a corresponding limit 420 for the attribute, the online concierge system 140 does not assign the order to pickers for selection, preventing pickers from attempting to fulfill orders for which the pickers have greater than a threshold probability of encountering a problem when fulfilling.

In the example of FIG. 4, the online concierge system 140 specifies initial values for each limit 420 of a corresponding attribute 400. The initial value may be a default value for a limit that the online concierge system 140 determines through any suitable method in various embodiments. Different attributes 400 have different initial values for their corresponding limits 420.

While conventional online concierge systems 140 maintain the initial values for limits 420 over time, maintaining a fixed value for a limit 420 of an attribute 400 may impair overall order fulfillment. For example, if the fixed value for the limit 420 of an attribute 400 is lower than what pickers are capable of fulfilling without having problems, the fixed value causes the online concierge system 140 to prevent assigning orders to pickers that the pickers are capable of fulfilling, reducing an overall number of orders fulfilled by the online concierge system 140. Conversely, if a fixed value for the limit 420 of an attribute 400 is higher than what pickers are capable of fulfilling without having problems, the online concierge system 140 assigns orders to pickers that the pickers are unable to fulfill without encountering one or more problems. An increased frequency of order fulfillment problems decreases customer satisfaction with the online concierge system 140, reducing a number of orders subsequently received by the online concierge system 140.

To maintain limits 420 for different attributes 400 of orders that accurately reflect capabilities of pickers for fulfilling orders without having problems, the online concierge system 140 trains and stores an order validation model 425, as further described above in conjunction with FIG. 3. The order validation model 425 receives attributes of an order as input and outputs a probability of a picker having a problem with fulfilling the order. In some embodiments, the order validation model 425 receives attributes of an order and characteristics of a picker and outputs a probability of the picker having a problem fulfilling the order. As further described above in conjunction with FIG. 3, the online concierge system 140 trains the order validation model 425 based on orders that were previously fulfilled by pickers, allowing the order validation model 425 to leverage previous order fulfillment by various pickers to determine a probability of pickers having a problem with order fulfillment.

After training and storing the order fulfillment model 425, the online concierge system 140 selects an attribute 400 of an order and determines a limit 420 for the selected attribute 400 using the order validation model 425. In the example of FIG. 4, the online concierge system 140 selects the weight 405 of the order. For the selected attribute (e.g., the weight 405), the online concierge system 140 obtains a set 430 of multiple different values for the selected attribute. In some embodiments, different values of the set 430 are separated by a fixed amount. Further, in some embodiments, a range between a maximum value of the set 430 and a minimum value of the set 430 is based on the selected attribute in some embodiments, so selection of an attribute 400 affects the range of values included in the set 430.

The online concierge system 140 applies the order validation model 425 to attributes of orders having different values of the set 430 for the selected attribute 400. In various embodiments, the online concierge system 140 fixes values of other attributes 400 of the order and changes the value of the selected attribute 400 to a different value, with the order attribute fulfillment module 425 variously applied to different combinations of the fixed values of other attributes and values of the selected attribute 400. Applying the order validation model 425 to different values of the set 430 for the selected attribute evaluates how each value of the set 430 for the selected attribute 400 affects a probability of having a problem with fulfilling the order. In embodiments where the order validation model 425 also receives characteristics of a picker as input, values of the characteristics of the picker are fixed as different values of the set 430 are used for the selected attribute 400. Further, the online concierge system 140 may apply the order validation model 425 to a specific value of a characteristic of a picker and to different values of the set 430 for the selected attribute 400 and apply the order validation model 425 to an alternative value of the characteristic of the picker and to values of the set 430 for the selected attribute.

Applying the order validation model 425 to the different values of the set 430 for the selected attribute generates a set of probabilities of having a problem with fulfilling an order. Each probability corresponds to a different value of the set 430 for the selected attribute 400. In the example of FIG. 4, value 430A of the selected attribute results in probability 435A of having a problem with fulfilling an order, while value 430B of the selected attribute results in probability 435B of encountering a problem with fulfilling the order. Similarly, value 430C of the selected attribute results in probability 435C of having a problem with fulfilling the order. Hence, applying the order validation model 425 to different values of the set 430 determines probabilities of a picker having a problem fulfilling an order when the order has different values for the selected attribute 400. In the example of FIG. 4, probability 435A, probability 435B, and probability 435C correspond to the weight 405 of an order having value 430A, value 430B, and value 430C, respectively.

Based on the probabilities 435A, 435B, 435C determined for different values 430A, 430B, 430C of the selected attribute (e.g., the weight 405 in FIG. 4), the online concierge system 140 selects 440 a value for the limit of the selected attribute. In the example of FIG. 4, the online concierge system 140 selects 440 a value for the limit of the weight 405 of an order using the probabilities 435A, 435B, 435C. In various embodiments, the online concierge system 140 selects a probability 435A, 435B, 435C that is less than a threshold probability and is nearest to the threshold probability. The online concierge system 140 selects 440 the value corresponding to the selected probability as the limit for the selected attribute. Using the selection criteria in the previous example, the threshold probability specifies a maximum probability of a problem with fulfilling the order, and selecting a probability nearest to the threshold probability and less than the threshold probability maximizes a number of orders that the online concierge system 140 accepts for fulfillment without exceeding the threshold probability of picker having a problem with fulfilling an order.

The online concierge system 140 stores the selected value based on the probabilities 435A, 435B, 435C as the limit for the selected attribute. In the example of FIG. 4, probability 435B is nearest the threshold probability and is less than the threshold probability, so the online concierge system 140 selects 440 value 430B, corresponding to probability 435B, as the limit for the weight 405 of an order. Values of weights of subsequently received orders are compared to value 430B by the online concierge system 140 to determine whether a subsequently received order is capable of being assigned to a picker. In various embodiments, the online concierge system 140 periodically selects an attribute 400 of orders and determines a limit for a value of the selected attribute 400 as further described above, allowing modification of the limit based on fulfillment of orders by pickers. This allows the limit for an attribute 400 to account for variations in capabilities of pickers to fulfill orders, increasing a number of orders capable of being assigned to pickers while reducing a probability of pickers encountering problems with order fulfillment from attributes of orders.

While FIGS. 3 and 4 describe using the order validation model to determine limits for one or more attributes of orders that determine whether the online concierge system 140 assigns a picker for fulfilling an order, the order validation model may also determine whether an order is capable of being assigned to a particular picker for fulfillment. FIG. 5 is a flowchart of one or more embodiments of a method for the online concierge system 140 determining whether a picker is capable of fulfilling an order using an order validation model. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system 140 without human intervention.

The online concierge system 140 receives 505 an order from a customer, with the order identifying a retailer from whom the order is fulfilled and one or more items to obtain from the retailer. In various embodiments, the online concierge system 140 displays an ordering interface to the customer for creating the order, as further described above in conjunction with FIGS. 1 and 2. Through the ordering interface, the customer selects items for inclusion in the order, specifies quantities of each item included in the order, and identifies a time interval for fulfillment of the order.

In various embodiments, the online concierge system 140 compares attributes of the order to corresponding limits determined using an order validation model, as further described above in conjunction with FIGS. 3 and 4. As further described above in conjunction with FIG. 3, attributes of an order are based on attributes of items included in the order. In response to an attribute of the order exceeding a limit for the attribute, the online concierge system 140 determines there is greater than a threshold probability of a picker having a problem with fulfilling the order. In response to an attribute exceeding a limit, the online concierge system 140 displays an interface to the customer indicating that the order cannot be fulfilled by the online concierge system. The interface may identify one or more attributes of the order to modify to enable fulfillment of the order by a picker. For example, the interface identifies the attribute of the order exceeding a limit and a message requesting that the customer reduce the value of the identified attribute.

After receiving an indication from the customer that the order is completed (i.e., that the customer has completed selecting items and specifying fulfillment of the order), the online concierge system 140 identifies 510 a picker for fulfilling the order. In some embodiments, the online concierge system 140 displays an order selection interface to pickers that includes orders received from one or more customers. The order selection interface includes information describing each order, such as a location where an order is to be delivered, a retailer from which items in the order are to be obtained, an amount of compensation the picker receives for fulfilling the order, or other information describing the order. In some embodiments, the online concierge system 140 identifies 510 the picker as a picker from whom the online concierge system 140 received an indication of availability to fulfill an order or a request for an order to fulfill.

The online concierge system 140 determines characteristics of the picker from data stored in association with the picker by the online concierge system 140, as further described above in conjunction with FIG. 2. The online concierge system 140 applies 515 the order validation model, further described above in conjunction with FIGS. 3 and 4, to attributes of the order and to characteristics of the picker. Based on the attributes of the order and the characteristics of the picker, the order validation model determines a probability of the picker having a problem fulfilling the order.

From the probability of the identified picker having a problem fulfilling the order, the online concierge system 140 presents 520 an indication of the picker's capability to fulfill the order. In some embodiments, in response to the probability of the picker having a problem fulfilling the order exceeding a threshold probability, the online concierge system 140 visually distinguishes the order from other orders for which the order validation model determined a probability of having a problem fulfilling the order that is less than the threshold probability. For example, an icon is displayed proximate to information identifying the order having greater than the threshold probability of the picker having a problem fulfilling the order. As another example, the order having greater than the threshold probability of the picker having a problem fulfilling the order is displayed in a different font, in a different color, or in a different format than other orders having less than threshold probability of the picker having a problem fulfilling the order. In various embodiments, the online concierge system 140 prevents the picker from selecting an order having a greater than the threshold probability for having a problem with fulfillment via the order selection interface, reducing a likelihood of the customer being dissatisfied with fulfillment of the order.

In some embodiments, the online concierge system 140 applies 515 the order validation model to each order available for display to the picker via an order selection interface prior to generating the order selection interface. The online concierge system 140 excludes orders having greater than the threshold probability of a picker encountering a problem with order fulfillment from presentation via the interface. This limits display of orders by the order selection interface to orders having less than the threshold probability of the picker having a problem with order fulfillment to prevent the picker from selecting an order for which the picker has greater than the threshold probability of encountering a problem with fulfillment.

Alternatively, the online concierge system 140 applies 515 the order validation model to the order in response to the picker selecting the order for fulfillment via the order selection interface or through another input. In response to the order validation model determining greater than or equal to the threshold probability of the picker having a problem fulfilling the order, the online concierge system 140 displays a message to the picker that the picker is unable to fulfill the order and prevents assignment of the order to the picker for fulfillment. However, in response to the order validation model determining less than the threshold probability of the picker having a problem fulfilling the order, the online concierge system 140 displays a message or another indication to the picker that the order is assigned to the picker for fulfillment. Such embodiments prevent the online concierge system 140 from assigning an order for which the picker has greater than the threshold probability of encountering a problem with fulfillment to the picker, decreasing a likelihood of the customer being unsatisfied with how the order was fulfilled.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, at a computer system comprising a processor and a computer-readable medium, comprising:
maintaining a range of values for an attribute for orders to be fulfilled by an online concierge shopping system;
applying an order validation model to each value of the range of values, the order validation model determining a probability that a picker would encounter a problem fulfilling the order based at least in part on the value of the attribute, wherein the order validation model is trained by:
obtaining a training dataset including a plurality of training examples, each training example including a value for the attribute for one of a plurality of previous orders and a label indicating whether a picker from the training example encountered a problem fulfilling the previous order,
applying the order validation model to each training example of the training dataset to generate a predicted probability that the picker from the training example encountered a problem fulfilling the previous order,
evaluating a loss function for the order validation model, for each training example, using the predicted probability and the label of the training example, and
updating one or more parameters of the order validation model by backpropagation based on the evaluating;
selecting a value for the selected attribute from the range of values based on the probabilities that a picker would encounter a problem fulfilling the order determined from applying the order validation model to each value of the range of values of the attribute; and
storing the selected value as a limit for the selected attribute.

2. The method of claim 1, wherein selecting a value for the selected attribute from the range of values comprises selecting a value corresponding to a probability nearest a threshold probability and less than the threshold probability.

3. The method of claim 1, wherein selecting a value for the selected attribute from the range of values comprises selecting a value corresponding to a probability less than a threshold probability.

4. The method of claim 1, wherein storing the selected value as a limit for the selected attribute comprises modifying a stored value for the limit for the selected attribute to the selected value.

5. The method of claim 1, further comprising:
receiving an additional order for fulfillment by the computer system;
comparing attributes of the additional order to corresponding limits stored for the attributes of the additional order; and
displaying an interface to a customer from whom the additional order was received indicating the additional order cannot be fulfilled in response to at least one attribute of the additional order exceeding a corresponding limit.

6. The method of claim 1, wherein applying the order validation model to each training example of the training dataset comprises applying the order validation model to different combinations of values for attributes of the order, each combination of values including a different value of the range of values for the selected attribute and fixed values for other attributes of the order.

7. The method of claim 1, wherein the order validation model determines the probability of the picker encountering the problem with fulfilling the order based on attributes of the order and characteristics of the picker.

8. The method of claim 6, wherein applying the order validation model to each training example of the training dataset comprises applying the order validation model to different combinations of values for attributes of the order and characteristics of the picker, each combination including a different value of the range of values for the selected attribute, fixed values for other attributes of the order, and fixed values for characteristics of the picker.

9. The method of claim 1, wherein the selected attribute of the order is one or more of: a weight of the order, a number of items in the order, dimensions of the order, and inclusion of one or more items with greater than a threshold dimension in the order.

10. A computer program product comprising a non-transitory computer readable storage medium having instructions encoded thereon that, when executed by a processor, cause the processor to perform steps comprising:
maintaining a range of values for an attribute for orders to be fulfilled by an online concierge shopping system;
applying an order validation model to each value of the range of values, the order validation model determining a probability that a picker would encounter a problem fulfilling the order based at least in part on the value of the attribute, wherein the order validation model is trained by:
obtaining a training dataset including a plurality of training examples, each training example including a value for the attribute for one of a plurality of previous orders and a label indicating whether a picker from the training example encountered a problem fulfilling the previous order,
applying the order validation model to each training example of the training dataset to generate a predicted probability that the picker from the training example encountered a problem fulfilling the previous order,
evaluating a loss function for the order validation model, for each training example, using the predicted probability and the label of the training example, and
updating one or more parameters of the order validation model by backpropagation based on the evaluating;
selecting a value for the selected attribute from the range of values based on the probabilities that a picker would encounter a problem fulfilling the order determined from applying the order validation model to each value of the range of values of the attribute; and
storing the selected value as a limit for the selected attribute.

11. The computer program product of claim 10, wherein selecting a value for the selected attribute from the range of values comprises selecting a value corresponding to a probability nearest a threshold probability and less than the threshold probability.

12. The computer program product of claim 10, wherein selecting a value for the selected attribute from the range of values comprises selecting a value corresponding to a probability less than a threshold probability.

13. The computer program product of claim 10, wherein storing the selected value as a limit for the selected attribute comprises modifying a stored value for the limit for the selected attribute to the selected value.

14. The computer program product of claim 10, wherein the non-transitory computer readable storage medium further has instructions encoded thereon that, when executed by the processor, cause the processor to perform steps comprising:
receiving an additional order for fulfillment;
comparing attributes of the additional order to corresponding limits stored for the attributes of the additional order; and
displaying an interface to a customer from whom the additional order was received indicating the additional order cannot be fulfilled in response to at least one attribute of the additional order exceeding a corresponding limit.

15. The computer program product of claim 10, wherein applying the order validation model to each training example of the training dataset comprises applying the order validation model to different combinations of values for attributes of the order, each combination of values including a different value of the range of values for the selected attribute and fixed values for other attributes of the order.

16. The computer program product of claim 10, wherein the order validation model determines the probability of the picker encountering a problem with fulfilling the order based on attributes of the order and characteristics of the picker.

17. The computer program product of claim 16, wherein applying the order validation model to each training example of the training dataset comprises applying the order validation model to different combinations of values for attributes of the order and characteristics of the picker, each combination including a different value of the range of values for the selected attribute, fixed values for other attributes of the order, and fixed values for characteristics of the picker.

18. The computer program product of claim 10, wherein the selected attribute of the order is one or more of: a weight of the order, a number of items in the order, dimensions of the order, and inclusion of one or more items with greater than a threshold dimension in the order.

19. A system comprising;
a processor; and
a non-transitory computer readable storage medium having instructions encoded thereon that, when executed by the processor, cause the processor to perform steps comprising:
maintaining a range of values for an attribute for orders to be fulfilled by an online concierge shopping system;
applying an order validation model to each value of the range of values, the order validation model determining a probability that a picker would encounter a problem fulfilling the order based at least in part on the value of the attribute, wherein the order validation model is trained by:
obtaining a training dataset including a plurality of training examples, each training example including a value for the attribute for one of a plurality of previous orders and a label indicating whether a picker from the training example encountered a problem fulfilling the previous order,
applying the order validation model to each training example of the training dataset to generate a predicted probability that the picker from the training example encountered a problem fulfilling the previous order,
evaluating a loss function for the order validation model, for each training example, using the predicted probability and the label of the training example, and
updating one or more parameters of the order validation model by backpropagation based on the evaluating;
selecting a value for the selected attribute from the range of values based on the probabilities that a picker would encounter a problem fulfilling the order determined from applying the order validation model to each value of the range of values of the attribute; and
storing the selected value as a limit for the selected attribute.

20. The system of claim 19, wherein selecting a value for the selected attribute from the range of values comprises selecting a value corresponding to a probability nearest a threshold probability and less than the threshold probability.
